(19) United States
(12) Patent Application Publication
(10) Pub. No.: US 2019/0106981 A1
(43) Pub. Date: Apr. 11, 2019

(54) METHOD AND APPARATUS FOR DETERMINING EQUIPMENT USAGE

(71) Applicant: TESTERS, INC., OKLAHOMA CITY, OK (US)

(72) Inventors: STEPHEN C. HAILEY, EDMOND, OK (US); JOHN MATTHEW WILKES, OKLAHOMA CITY, OK (US); SAMUEL THOMAS McJUNKIN, EDMOND, OK (US); LANDON EDWARD BROCKERT, OKLAHOMA CITY, OK (US)

(21) Appl. No.: 16/087,756

(22) PCT Filed: Mar. 22, 2017
(86) PCT No.: PCT/US17/23606

§ 371 Date: Sep. 24, 2018

Related U.S. Application Data
(60) Provisional application No. 62/311,847, filed on Mar. 22, 2016.

(51) Int. Cl. E21B 47/06; G06Q 30/06; G06Q 30/02

(52) U.S. Cl. CPC E21B 47/065; G06Q 30/0283; G06Q 30/0645; E21B 47/06

(57) ABSTRACT

Tools are often leased or rented by the owners of the tools. The price paid to rent or lease the tools can be based on a number of factors including the total time in which the downhole tool is in use, the time in possession of the renter, number of times the tool goes in and out of the well, or other factors. To accurately estimate the price owed to the owner of the tool by the renter of the tool, monitoring apparatuses equipped with usage trackers can be utilized to quantitatively measure time usage, possession usage or other basis from which a fee is to be calculated. The quantitative measurements taken by the usage tracker may be used to determine for example, the amount of time a tool is used or possessed to allow fee calculations, or simply to determine usage time for maintenance purposes.

### FIELD

The present disclosure relates generally to tool usage calculations, and more specifically, to apparatuses and methods of recording usage of tools and equipment in a rental fee environment.

### BACKGROUND

Many tools and finite service life components are used in the oil and gas, mining, manufacturing, aerospace and other industries. For example, in the oil and gas industry, various tools are used including rotary drill bits, hole-enlarging tools, tubulars, downhole motors, impact tools, deflection tools, fishing tools, testing tools, cementing tools, coiled-tubing drilling tools and others.

In many cases, these tools are rented or leased from the tool manufacturer. In other cases, an end user may simply be interested in the actual usage time of particular tools or components for other purposes.

In a rental scenario, when a tool is rented the owner and the renter of the tool must agree on pricing, which may be done in different ways. For example, the renter can pay based on the total amount of time the renter is in possession of the tool. Other pricing methods include payment based on the time the tool is down hole or in other working environments, or based on the time the tool is actually operating.

As an example, for many pricing methods for downhole tools, the renter of the downhole tool must self-report the usage of the tool. In an arrangement where the renter of the tool pays for the tool based on the total amount of time the tool spends in the well, the renter must record the amount of time the downhole tool spent in a well, report that number to the owner of the downhole tool, and the price owed to the owner is calculated according to a previously agreed upon formula. Because the owner of the tool is not in control of recording the usage of the tool, disagreements can arise between the owner of the tool and the renter of the tool.

### SUMMARY

In accordance with the present disclosure, an apparatus and method for calculating the usage of tools and equipment are provided.

In one embodiment, an apparatus for monitoring tool usage is provided. The apparatus comprises a downhole tool, a measuring apparatus, microcontroller, and a usage tracker. The measuring apparatus is configured to measure a parameter associated with the tool wherein the measured parameter reflects a condition of the downhole tool. The microcontroller is configured to receive a signal that represents the measured parameter and activate a usage tracker when a change in the condition of the tool is measured. The usage tracker is configured to take a measurement for use in determining a use condition of the tool. For example the usage tracker may comprise a timer that starts when a tool moves from a non-in-use to an in-use condition and stops when the tool moves from the in-use to the non-in-use condition. The usage tracker may likewise comprise a counter that simply measures, or marks the times that the tool changes use conditions, so that the time therebetween can be calculated.

In another embodiment, there is provided a method for determining tool usage comprising the steps of: measuring a parameter associated with the tool; taking a quantitative measurement(s) with a usage tracker when the measured parameter indicates a condition of the tool has changed between a non-in-use condition to an in-use condition; and taking a quantitative measurement(s) with the usage tracker when the measured parameter indicates the condition of the tool has changed between the in-use condition to the non-in-use condition. The quantitative measurement may be the time at which the use condition changes, so that an overall in-use time may be calculated. Alternatively, the usage tracker may be a timer that starts and stops upon the change to the in-use and non-in-use conditions respectively.

### BRIEF DESCRIPTION OF THE DRAWINGS

FIG. 1 is a perspective, cross-sectional view of a downhole tool including a monitoring apparatus as provided by the present disclosure.

FIG. 2 is a perspective, cross-sectional view of a monitoring apparatus as provided by the present disclosure.

FIG. 3 is a perspective, cross-sectional view similar to FIG. 1 showing a cross-sectional view of the monitoring apparatus.

FIG. 4 is a block diagram illustrating steps in the method of tracking usage provided by the present disclosure.

FIG. 5 is perspective, cross-sectional view similar to FIG. 1 showing a monitoring apparatus with a threaded housing in accordance with an embodiment of the present disclosure.

FIG. 6 is a perspective view of a tamper-proof cap as provided by the present disclosure.

FIG. 7 is a perspective view of a monitoring apparatus with a threaded housing without a tamper-proof cap.

FIG. 8 is a perspective view of a monitoring apparatus with a threaded housing with a tamper-proof cap.

FIG. 9 is a perspective, cross-sectional view of a monitoring apparatus with a threaded housing without a tamper-proof cap.

FIG. 10 is a perspective, cross-sectional view of a monitoring apparatus with a threaded housing with a tamper-proof cap.

FIG. 11 is a schematic diagram of a system utilizing the monitoring apparatus as provided by the present disclosure.

### DETAILED DESCRIPTION

The present disclosure may be understood more readily by reference to these detailed descriptions. For simplicity and clarity of illustration, where appropriate, reference numerals may be repeated among the different figures to indicate corresponding or analogous elements. In addition, numerous specific details are set forth in order to provide a thorough understanding of the various embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

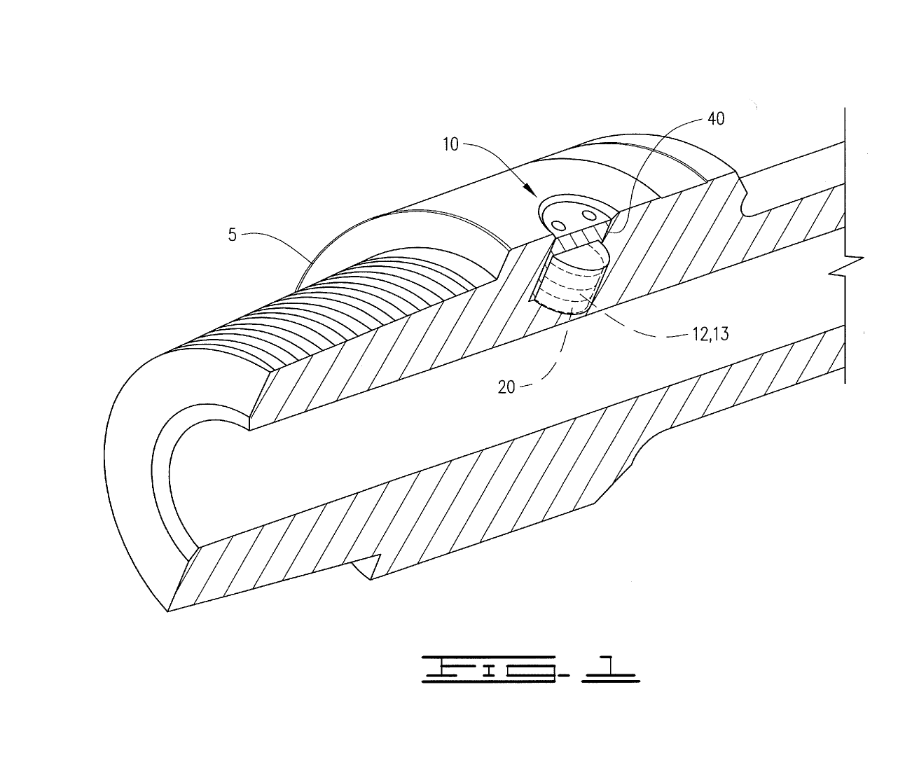

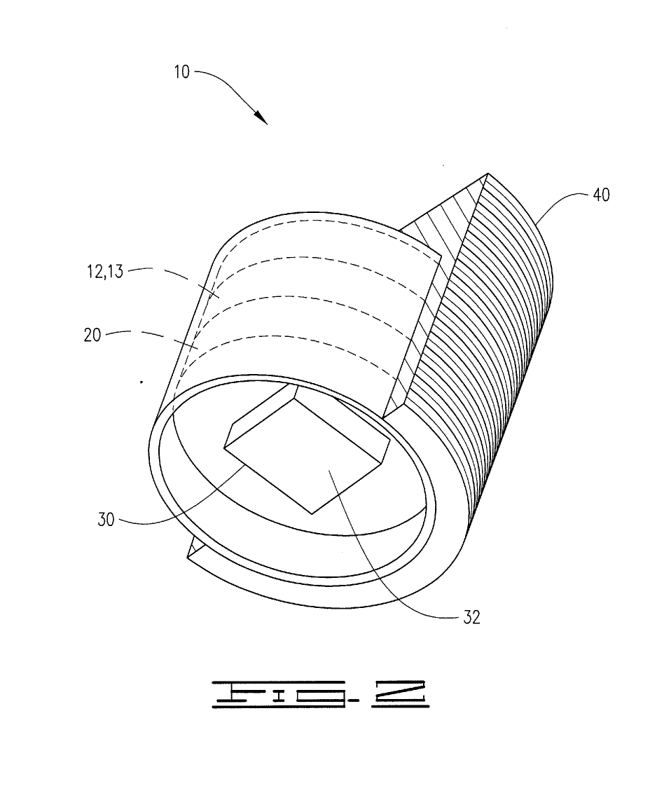

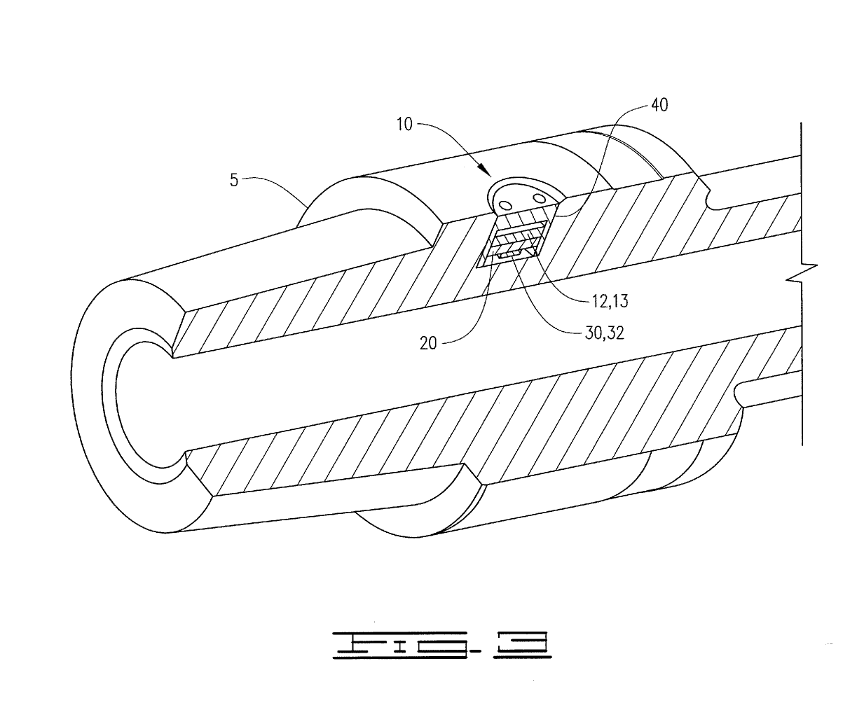

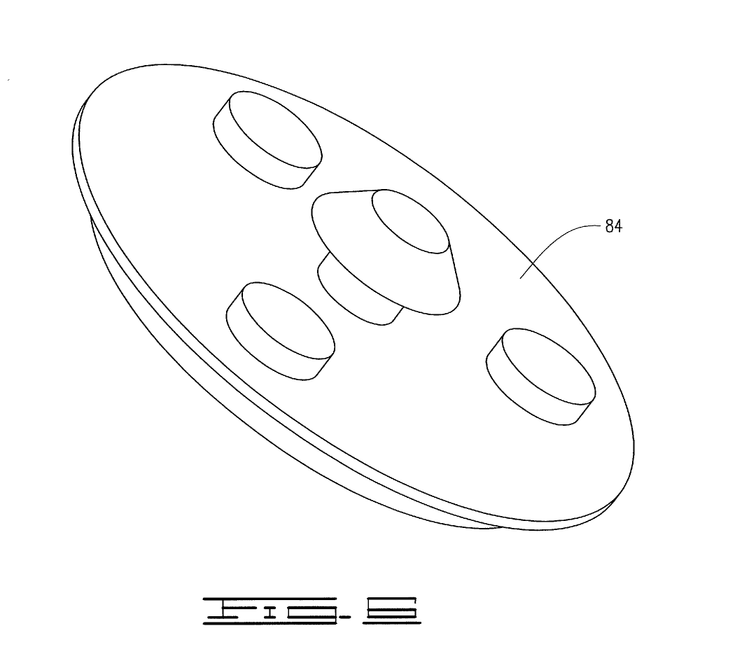

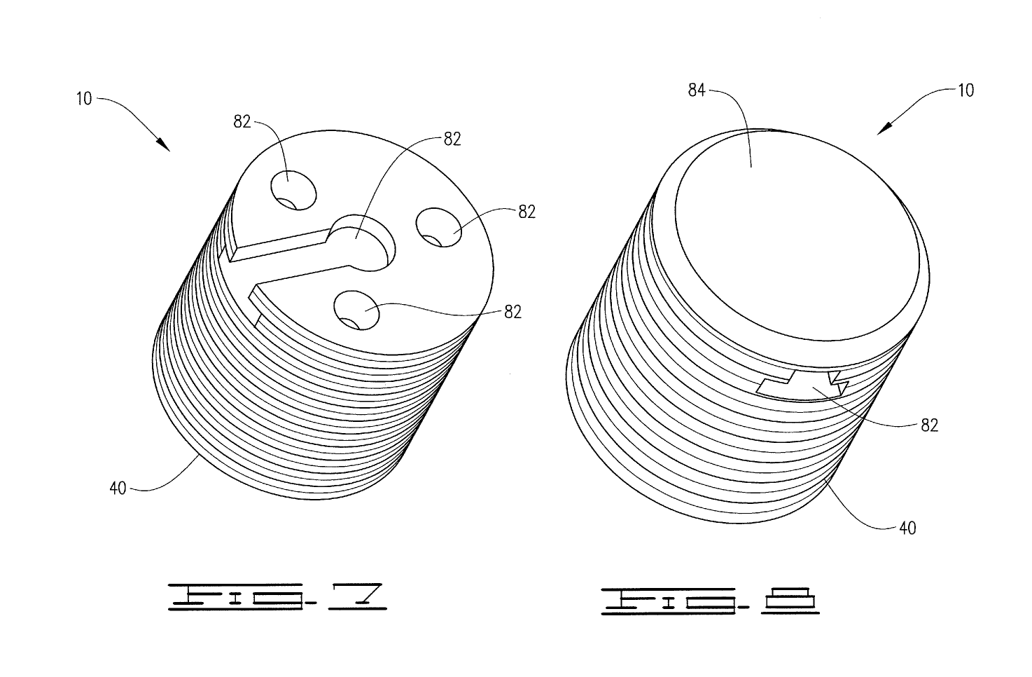

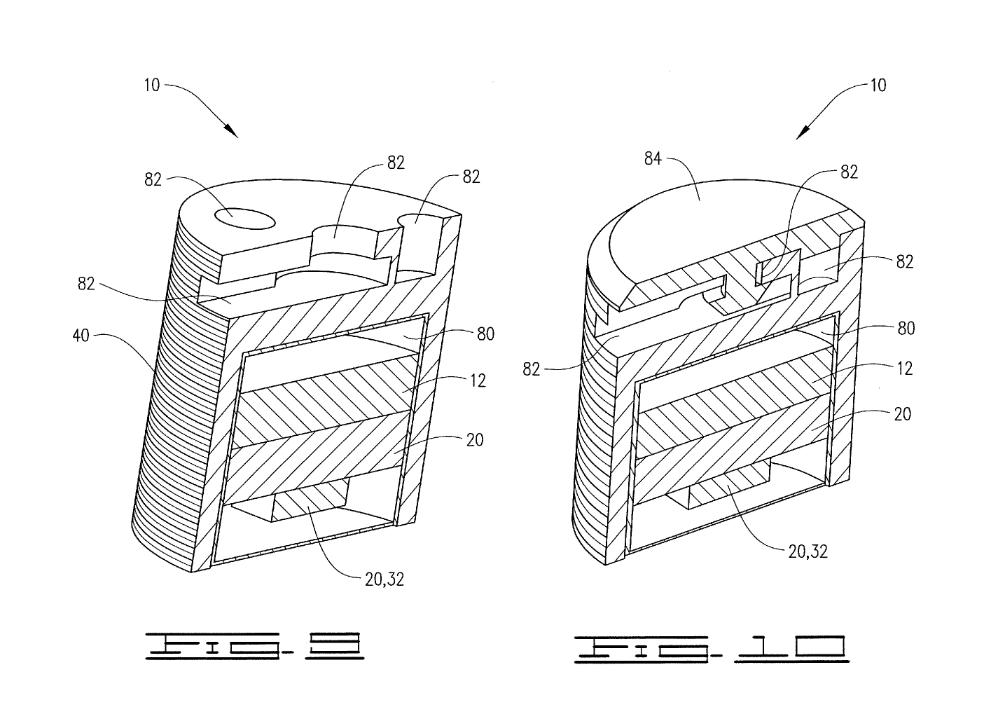

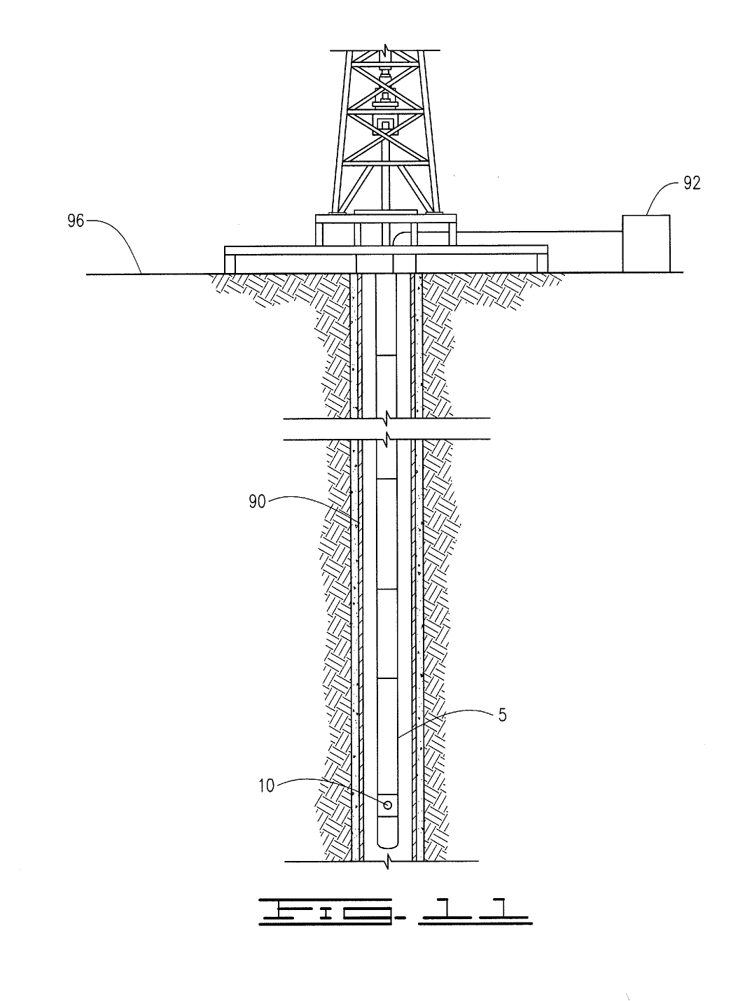

Referring generally to FIGS. 1-10, the inventive apparatus for determining equipment usage is illustrated and generally designated by the numeral 10. As shown by the drawings, the general form of monitoring apparatus 10 includes a measuring apparatus 20, microcontroller 30, and usage tracker 32. As used herein, “microcontroller” refers to a small computer on a single integrated circuit containing a processor core, memory, and programmable input/output peripherals. As used herein, “usage tracker” means a timer, clock, counter, visual indicator, or other device by which a measurement may be taken. As used herein, “visual indicator” may refer to a flashing indicator that is utilized to signal when a tool has eclipsed a certain amount of usage, i.e., time of use or number of trips into a wellbore, and needs to be replaced, or signals when a tool is close to being out of service based on the amount of usage, i.e., time of use or number of trips into a wellbore. One of ordinary skill in the art will recognize that a power supply 12 is inherently required to power monitoring apparatus 10. For example, in some embodiments, power supply 12 may be a battery 13. Measuring apparatus 20 included in monitoring apparatus 10 may measure a parameter associated with downhole tool 5. Signals representative of the measured parameter(s) may be sent to microcontroller 30, which can activate usage tracker 32. Usage tracker 32 may be a part of microcontroller 30. Measuring apparatus 20 may in some embodiments likewise be a part of microcontroller 30.

The measured parameter associated with downhole tool 5 may be, for example, temperature or pressure of the area surrounding the tool or component. The measured parameter may be compared against a threshold parameter that is known or preselected. A change in the parameter to the identified threshold may indicate for example that downhole tool 5 is in a wellbore or is in use. Likewise, a change can indicate that downhole tool 5 is no longer in use, or no longer in a wellbore. Alternatively, measuring apparatus 20 can measure whether downhole tool 5 is moving, or whether and how long downhole tool 5 experiences a change or deviation from ambient conditions so that the usage of downhole tool 5, i.e., the amount of time downhole tool 5 is used, or the number of times downhole tool 5 has been tripped in and out of the well, can be determined. Further examples of using measuring apparatus 20 to determine if/when and how many times downhole tool 5 has been tripped in and out of the well are provided below. Regardless of the particular measuring apparatus 20 used, measuring apparatus 20 will produce an output, whether an analog or digital signal. The signal produced by measuring apparatus 20 will be sent to microcontroller 30. Microcontroller 30 will activate usage tracker 32 when the triggering event, for example, temperature threshold, pressure threshold or movement, occurs, from which fees may be assessed or a maintenance schedule can be determined based on measurements or other information provided by usage tracker 32.

Microcontroller 30 may store and/or transmit the pertinent measurement received from usage tracker 32. For example, if the basis for the rental fee is the amount of time spent in the well, measuring apparatus 20 will send a signal to microcontroller 30 to activate usage tracker 32, in this example a clock or timer, to record the time of day, or start a timer, when a first threshold temperature or other triggering event occurs indicating downhole tool 5 is in the wellbore. The temperature may be, for example 125° F. Microcontroller 30 can activate usage tracker 32 to record the information, i.e., the time at which the threshold was reached, or start the timer, for later retrieval and/or transmit the information in real time to a surface computer. When a temperature at or below a second threshold is reached indicating downhole tool 5 is no longer in the well, measuring apparatus 20 signals microcontroller 30 to deactivate usage tracker 32 which records the time of day, or stops the timer. It is understood that usage tracker 32 may comprise a part of microcontroller 30.

Usage tracker 32 may record the time of the event, or may start the timer upon the initial triggering event, and record the time or stop the timer at the second triggering event, which indicates downhole tool 5 is no longer in the well. The first and second threshold temperatures may be the same or may be different. In other words, the first threshold temperature will be reached as temperature increases, and the second threshold temperature reached as temperature decreases when downhole tool 5 is being removed from the well. When the time measurement or other information from usage tracker 32 is stored in microcontroller 30, monitoring apparatus 20 may be later connected to a surface computer and the pertinent measurement or other information can be transferred to the surface computer. Other embodiments may use real time transmission of usage tracker 32 measurements related to the tool usage. The time measurements generated from usage tracker 32 can be sent to the owner of downhole tool 5 and the user so that an accurate rental fee is calculated.

The particular measuring apparatus 20 and microcontroller 30 can vary depending on the application requirements or relating to a preferred pricing method agreed upon by the owner and the renter, availability of particular equipment, or the advantage of using a particular embodiment in specific situations. Accordingly, the following examples are not limiting, but merely illustrate possible embodiments consistent with the present disclosure.

Examples of suitable pricing methods include charging the renter for the downhole tool based on: (1) the time downhole tool 5 is in possession of the renter; (2) the time downhole tool 5 is in a wellbore; (3) the time that downhole tool 5 is in use; and (4) the number of times downhole tool 5 is placed into and removed from a wellbore, and combinations thereof. As will be discussed more fully below, the particular method of charging a renter chosen will determine in part the particular measuring apparatus 20 and the particular microcontroller 30. Another basis might be the number of times downhole tool 5 has been used, or actuated to perform in the well. For example, usage tracker 32 may be a counter that counts the number of times downhole tool 5 creates an impact in the well, or makes a cut, or performs the specific task for which it is designed. Further examples could include gathering data from usage tracker 32 for use in determining when maintenance or replacement for a particular downhole tool 5 may be required.

Depending on the particular pricing method chosen, a suitable measuring apparatus 20 is chosen. For example, wellbores generally have an elevated temperature relative to the surface. Therefore, if the pricing method charges the renter based on usage tracker 32 measuring the amount of time the downhole tool is in a wellbore, monitoring apparatus 10 may include a measuring apparatus 20 that is a temperature sensor, or other apparatus that measures temperature.

There are a large number of suitable pricing methods and also a large number of suitable measuring apparatuses 20 suitable for use with each pricing method. However, in view of the present disclosure, one having ordinary skill in the art will be able to select a suitable pricing method and a suitable measuring apparatus 20 and microcontroller 30 with a suitable corresponding usage tracker 32, and it is not necessary to discuss every combination in detail.

If the pricing method is based upon time in the wellbore, a variety of sensors can be chosen as the measuring apparatus 20 to determine the change in temperature. For example, thermocouples, thermistors, resistance thermometers, pyrometers, infrared tools, and other thermometers can be used as measuring apparatus 20. For measuring pressure, a variety of pressure measuring apparatuses can be used, including elastic pressure sensors, capacitive pressure sensors, piezoelectric pressure sensors, piezoresistive meters, strain gauge pressure sensors and other pressure measuring equipment can be used as measuring apparatus 20. If the pricing method is based upon trips into the well or use of downhole tool 5, an accelerometer including piezoelectric accelerometers, Gauss meter, gyroscope, or a seismograph can be used as measuring apparatus 20 to determine movement and/or vibration of the tool.

In some embodiments, microcontroller 30 may be programmed such that power supply 12 is preserved. For ease of explanation, the following embodiment description will utilize a battery 13 as power supply 12. Microcontroller 30 may be programmed such that it automatically turns on or off at predetermined times. Predetermined times may include, but are not limited to, a triggering event occurring, an elapsed amount of time of inactivity, at set intervals of time, or immediately upon completion of a quantitative measurement by usage tracker 32. This enables microcontroller 30 to not expend power during the entirety of use of downhole tool 5, such that battery 13 may be utilized for a longer period of time. One of ordinary skill in the art will appreciate that microcontroller 30 may be programmed in various ways to achieve optimal battery 13 life. In one example, the battery will be in a dormant state until first use, so that the monitoring apparatus 10 may be constructed for installation and use with a tool that is to be later built and utilized in a wellbore.

Monitoring apparatus 10 will in most cases removably attach to downhole tool 5 or equipment being tracked, but may be positioned in close proximity to downhole tool 5 or equipment. In some embodiments, monitoring apparatus 10 components may all be contained together in housing 40, such that monitoring apparatus 10 can be removably attached to downhole tool 5 or other equipment. In additional embodiments, monitoring apparatus 10 may include only microcontroller 30 along with usage tracker 32 and power supply 12 contained together in housing 40, such that an external sensor can be communicatively coupled with monitoring apparatus 10. The particular method of removably attaching monitoring apparatus 10 can vary. One of ordinary skill in the art will recognize that the means of removably attaching monitoring apparatus 10 to downhole tool 5 or other equipment may be achieved by any attachment means known in the art. If an external sensor is utilized, one of ordinary skill in the art will recognize that the means of removably attaching the external sensor to monitoring apparatus 10 may be achieved by any communicative coupling means known in the art such that signals can be transmitted from the external sensor to monitoring apparatus 10 or vice versa. For example, monitoring apparatus 10 can be removably connected to the downhole tool 5 utilizing a threaded connection as described herein. If desired, the monitoring apparatus may be connected to an outer surface of the tool with threaded fasteners, or other means known in the art. This allows for monitoring apparatus 10 to be removed from downhole tool 5 or equipment during non-use and put to the side, i.e., on a shelf and out of the way. Downhole tool 5 can be designed so that monitoring apparatus 10 can be positioned internally thereto, such as positioned within an interior of the downhole tool.

Monitoring apparatus 10 may vary in size based upon the downhole tool 5 or other equipment it is intended to be utilized with. For example, monitoring apparatus 10 may be as small as ½ inch in diameter, which includes all the necessary components including but not limited to microcontroller 30, usage tracker 32, power supply 12, and/or sensor in housing 40. One of ordinary skill in the art will appreciate monitoring apparatus 10 may be any size small enough to include all necessary components and still be utilized in various downhole tools 5 and other equipment. Monitoring apparatus 10 may be constructed of commercially available materials and components such that it may be utilized in environments where the temperature reaches as much as 500° F.

Measuring apparatus 20 can produce analog signals, digital signals or both. For simplicity purposes, the examples to follow utilize a usage tracker 32 for determining a quantitative amount of time, i.e., a timer. Whether analog or digital, the signal will trigger microcontroller 30 to activate usage tracker 32 to indicate a start, or beginning time and also the end or stop time. Microcontroller 30 may be a digital computer that can indicate to usage tracker 32 the beginning and end times for the pertinent condition on which the rental fee or maintenance schedule is to be based. Microcontroller 30 can receive and store or transmit the information (e.g, time information) from usage tracker 32 resulting from the signal received from measuring apparatus 20. For example, microcontroller 30 can receive digital information from measuring apparatus 20 or can receive information that has been translated from analog to digital using an analog to digital converter. Microcontroller 30 can store the time information in memory or other computer readable medium received from usage tracker 32. Microcontroller 30 may in some embodiments transmit the time information received from usage tracker 32 via a wireless transmitter or telecommunication device to a surface computer. In some embodiments, microcontroller 30 may be equipped with data storage means such that if power is lost to microcontroller 30, the quantitative measurements received from usage tracker 32 are maintained and accessible. In additional embodiments usage tracker 32 may be equipped with data storage means, such that if power is lost in monitoring apparatus 10, the quantitative measurements taken by usage tracker 32 are maintained and accessible.

Referring now specifically to FIGS.1-3, a monitoring apparatus in accordance with the present disclosure is provided. Monitoring apparatus 10 may be attached to downhole tool 5. Thus, monitoring apparatus 10 may include, but is not limited to, power supply 12, measuring apparatus 20, microcontroller 30, and usage tracker 32. All of the components of monitoring apparatus 10 may be potted together in housing 40. As discussed, measuring apparatus 20 for measuring temperature, pressure, vibration, movement or any other suitable parameter that may be used to reflect a change in the use condition of the tool 5. When a measured parameter reaches a determined threshold, measuring apparatus 20 will signal the microcontroller 30 to activate usage tracker 32, i.e., timer, to record the time, for example, the time at which the parameter reaches the threshold to (for example a threshold temperature) indicate the downhole tool 5 was placed in the well. The same events will occur when downhole tool 5 is removed. Measuring apparatus 20 will signal microcontroller 30 which will then activate usage tracker 32, i.e., timer, to record the stop time when the predetermined lower threshold temperature around the downhole temperature is reached, indicating downhole tool 5 is no longer in the wellbore. Alternatively, usage tracker 32 can be a clock that can be started and then stopped or usage tracker 32 can be a counter that may be indexed based on the signals received by microcontroller 30. Whatever parameter(s) are measured by monitoring apparatus 10, the pertinent usage tracker 32 quantitative measurement, i.e., the pertinent time or other data (use or trips in the well), used to calculate the rental may be transferred to a surface computer.

When the measured parameter initially reaches the threshold parameter, the microcontroller will recognize that downhole tool 5 is in an in-use condition activating usage tracker 32. The in-use condition may be for example when downhole tool 5 is in the well, or may be when downhole tool 5 is operating in general, regardless of whether or not downhole tool 5 is in the well. If the number of trips in and out of the well is the basis for payment, the in-use condition activating and deactivating usage tracker 32 can be the movement into and then out of the well. For example, if usage tracker 32 is a timer, microcontroller 30 will activate the timer when the first threshold is reached to indicate an in-use condition, and will deactivate the timer when a second threshold is reached to indicate a non-in-use condition. More specifically, if the in-use condition is simply being in a wellbore, when a particular temperature or pressure is reached to indicate that downhole tool 5 is in the wellbore, the timer will be activated to record the date and time at which downhole tool 5 is put into the wellbore. This occurs when the first predetermined threshold is met. When downhole tool 5 is removed, a second threshold parameter (for example, a second temperature) will be reached and the timer stopped and this interval will be recorded. The interval will be the amount of time downhole tool 5 was in use. In some embodiments, the first and second threshold parameters may be the same. An additional example, wherein usage tracker 32 is a timer and the actual operation of downhole tool 5 is the in-use condition, includes an accelerometer or one of the other sensors mentioned herein being utilized as measuring apparatus 20 to determine vibrations and/or other indications that downhole tool 5 is in use. Once the magnitude of the movement or other vibrations reaches a first threshold to reflect the operation of downhole tool 5, the timer will be activated. Once such vibrations or other movements cease and the second threshold is reached, the timer will be deactivated and the time between the two will constitute the in-use time.

In an embodiment wherein usage tracker 32 is a timer and the number of trips in and out of the well constitute the in-use condition being sought, the movement measured by an accelerometer or other measuring apparatus 20 will identify when downhole tool 5 is moving in a well. The initial movement down the well will cause the timer to activate or begin. Once downhole tool 5 stops, the timer will deactivate or stop. When downhole tool 5 is removed, movement will again be sensed and the timer will activate. In this scenario, a timer may not need to be used. The sensor may simply recognize the number of stops and starts to allow the number of trips to be calculated. If the total time downhole is the measure for the rental fee calculation, a timer will be used and the time intervals in which the tool was in the well can be calculated. In this scenario, it may be necessary to monitor other factors such as the distance and direction of movement so that it can be fully determined when downhole tool 5 was moved into or out of the well.

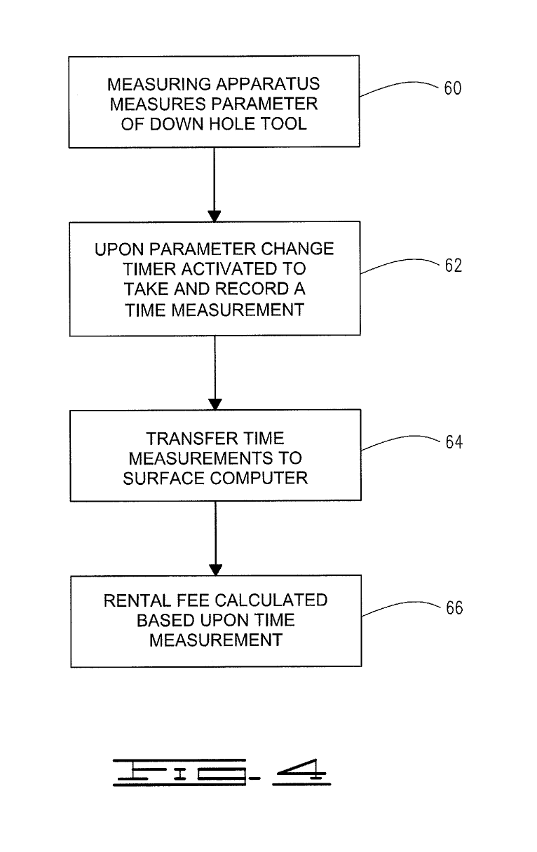

Turning specifically to FIG. 4, a flow chart depicting the flow of information in embodiments of the present disclosure is provided. For the sake of simplicity, the following example description utilizes a timer as usage tracker 32. At step 60, a parameter is measured by measuring apparatus 20. As discussed, the parameter may be temperature, pressure, movement, vibration or other information. When the parameter changes to a predetermined threshold, for example, a temperature that is high enough to reflect downhole tool 5 is in the well, the timer will be activated. When the temperature decreases to the second threshold parameter to reflect downhole tool 5 is not in the well, the timer is deactivated and the amount of time in the well is recorded. This is reflected at step 62. The difference in the first recorded time and the second recorded time will constitute the in-use time interval for purposes of fee calculation. Additional examples of thresholds include, but are not limited to, the first and second threshold parameters being the difference between an ambient state and an operating state. In these examples, usage tracker 32 can measure the total time downhole tool 5 was in the well, or trips in the well and the rental fee can be calculated accordingly. Additionally, by way of example, the parameter that causes usage tracker 32 to activate and deactivate can be based on a measurement of the number of times downhole tool 5 goes in or pulls out of the well, which will also provide a calculation for a rental fee based on trips. Another example of a measuring apparatus 20 is an accelerometer used to trigger the activation and deactivation of usage tracker 32, i.e., starting and stopping a timer based on the vibrations of downhole tool 5. The steps shown at 64 and 66 depict the process of transferring the usage tracker 32 measurements and calculating the appropriate fee, wherein the usage tracker 32 measurements are received by microcontroller 30 and then transferred to a surface computer (assuming no real time transfer occurred) and the rental fee is calculated based upon the measurements.

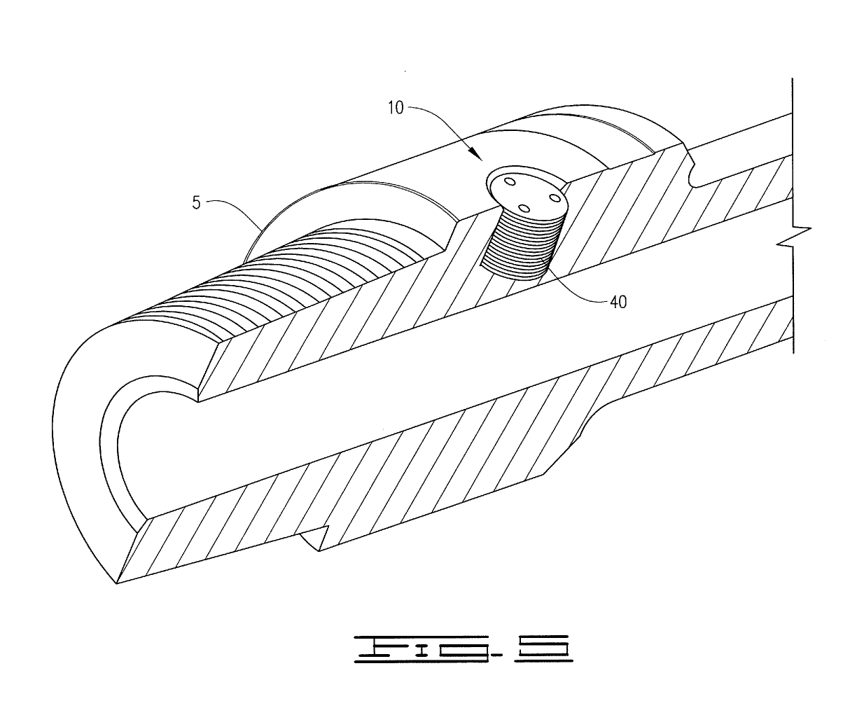

A specific embodiment is depicted in FIGS. 5-11. FIG. 5 shows a monitoring apparatus 10 with a housing 40. Housing 40 may be a threaded housing 40 that can be threaded into a downhole tool 5, as shown in FIG. 5. As explained above, downhole tool 5 may be any tool or equipment where tracking usage is necessary. Monitoring apparatus 10 includes a measuring apparatus 20, power supply 12 and a microcontroller 30 equipped with a usage tracker 32. Measuring apparatus 20, power supply 12, and microcontroller 30 are housed in the hollow interior 80 of housing 40. Housing 40 may have openings 82 to receive a tamper-proof cap 84 that can be positioned on top of housing 40 to prevent removal or reveal tampering of the monitoring apparatus 10 prior to the time it is returned to the owner of downhole tool 5. In this embodiment, tamper-proof cap 84 may be received by and pressed into housing 40 utilizing openings 82. Tamper-proof cap 84 can require a key or other tool maintained by the owner of the tool without which the monitoring apparatus 10 can not be removed. If desired, a tamper-proof cap that breaks away to indicate whether unauthorized access has been attempted or gained may be provided.

As explained herein, downhole tool 5 will be lowered into a well 90 below ground level 96 for any number of purposes. Well 90 in FIG. 11 is cased, but it is understood that well 90 may be a cased or uncased well. In the particular embodiment shown, the measuring apparatus 20 is of a type that will measure a temperature and so will be referred to herein as temperature sensor 20. Assuming for the purpose of this example that the rate or the fee to be charged to the user of downhole tool 5 is based on the amount of time that downhole tool 5 spends in the hole, thereby requiring usage tracker 32 be a timer or clock, temperature sensor 20 will recognize a change in temperature around downhole tool 5. For example, when the temperature around downhole tool 5 reaches a first threshold temperature to indicate downhole tool 5 is in the well, the sensor 20 will send a signal to microcontroller 30 which will activate usage tracker 32, in this embodiment a timer or clock, and record the time at which the first temperature threshold is reached. When downhole tool 5 is removed, such that the ambient temperature around downhole tool 5 reaches or goes below a second threshold to indicate downhole tool 5 is being, or has been removed from well 90, temperature sensor 20 will send a signal to microcontroller 30 which will deactivate usage tracker 32, in this embodiment a timer or clock, and record the time at which the lower temperature is reached. The time difference will be the time spent by downhole tool 5 in the well. Monitoring apparatus 10 can be removed from downhole tool 5 and connected by any number of communication methods, for example, USB, IR, RF, Serial, I2C or other means to a surface computer 92 and the usage tracker 32 measurement, in this embodiment, time, can then be recorded and sent to both the owner of downhole tool 5 and the user of downhole tool 5. Monitoring apparatus 10 may also incorporate a visual indicator like a flashing LED to signify that downhole tool 5 is ready to be replaced or almost out of service. In an additional embodiment, assuming several trips are made into well 90 and the rental is based on the number of trips into well 90, a usage tracker 32 that is a counter can be utilized whereby the number of times that the temperature cycles from the high threshold to the low threshold can be used to count the number of trips into well 90. In an additional embodiment, wherein the rental is based on the amount of time spent in well 90, utilizing a usage tracker 32 that is a clock, the difference in the first and second measured times can be used. The measured times can be used not only for calculating a fee, but for determining the length of time downhole tool 5 has been used so that tool life can be monitored. Such information is useful for determining when tools should be replaced and/or maintenance performed.

It is understood that the foregoing are merely examples and it could easily be a pressure sensing tool to measure pressure or an accelerometer utilized to measure movement or vibrations. Actual well data may or may not be recorded. If well data is recorded, the data is used in determining where triggering events have occurred and not for data logging purposes when sent to the surface computer 92. The measured parameter(s) are simply being used as a trigger to activate or deactivate usage tracker 32, i.e., to start/stop a clock, to record a particular time at which an event occurs, to activate a counter, or other usage tracking parameters required for a particular application. Thus, the device is utilized for the purpose of allowing owners and users of tools, equipment, and components to accurately determine the proper rental fee or to determine usage for purposes of maintenance or replacement of the tracked item.

Therefore, the present disclosure is well adapted to attain the ends and advantages mentioned, as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present disclosure. While apparatus and methods may be described in terms of “comprising,” “containing,” “having,” or “including” various components or steps, the apparatus and methods can also, in some examples, “consist essentially of” or “consist of” the various components and steps. Also, the terms in the claims have their plain, ordinary meaning unless otherwise explicitly and clearly defined by the specification.

What is claimed is:

1. An apparatus for use in a wellbore comprising:
a downhole tool;
a measuring apparatus for measuring a parameter associated with the tool, wherein the measured parameter reflects a condition of the downhole tool; and
a microcontroller configured to receive a signal representative of the measured parameter, wherein a usage tracker is activated when the measured parameter reflects a change in a use condition of the tool.

2. The apparatus of claim 1, wherein the microcontroller activates or deactivates the usage tracker upon the measured parameter reaching a predetermined threshold parameter.

3. The apparatus of claim 2, wherein the measured parameter is selected from the group consisting of temperature, pressure, movement, vibration, resistance, capacitance or magnetic field.

4. A system comprising the apparatus of claim 1 and a remotely located computer configured to receive usage information from the microcontroller.

5. The apparatus of claim 1 further comprising a visual indicator configured to indicate when the useful life of the tool is diminished or expired.

6. The apparatus of claim 1, wherein the usage tracker is selected from the group consisting of a timer, clock, or counter.

7. The apparatus of claim 1 further comprising a power supply coupled to the microcontroller, wherein the microcontroller is configured to automatically turn on and off at predetermined times.

8. The apparatus of claim 7, wherein the power supply is a battery.

9. A method of monitoring tool usage comprising;
measuring a parameter associated with the tool;
determining when the measured parameter indicates a condition of the tool has changed from a non-in-use condition to an in-use condition;
determining when the measured parameter indicates the condition of the tool has changed from the in-use condition to the non-in-use condition; and
calculating the total time the tool was in the in-use condition.

10. The method of claim 9, wherein the measured parameter associated with the tool is selected from the group consisting of temperature, pressure, movement, vibration, resistance, capacitance or magnetic field.

11. The method of claim 9, wherein the usage tracker is selected from the group consisting of a timer, clock, and counter.

12. The method of claim 9, wherein the tool is a downhole tool for use in a wellbore, and the in-use condition is selected from the group consisting of the amount of time the tool is in the wellbore, the amount of time the tool is in active operation, and the number of trips into and out of the wellbore.

13. The method of claim 9, further comprising:
sending a signal representative of the measured parameter to a microcontroller; and
activating a usage tracker with the microcontroller when the measured parameter indicates the condition of the tool has changed from the non-in-use condition to the in-use condition.

14. The method of claim 13 further comprising:
identifying a first threshold parameter at which the tool changes from a non-in-use to an in-use condition; and
the activating step comprising the usage tracker taking a first time measurement when the first threshold parameter is reached.

15. The method of claim 14 further comprising identifying a second threshold parameter at which the tool changes from the in-use to the non-in-use condition; and
the activating step comprising the usage tracker taking a second time measurement when the second threshold parameter is reached.

16. The method of claim 19, further comprising calculating a rental fee of the tool based upon the time measurements taken by the usage tracker

17. A system for calculating a rental fee for a downhole tool comprising:
a measuring apparatus for measuring a parameter that reflects a use condition of the downhole tool;
a microcontroller for receiving a signal representative of the use condition of the tool;
a usage tracker configured to activate when the measured parameter indicates a change in the use condition of the tool; and
a surface computer configured to receive the use condition information, whereby a rental fee is charged based on the use condition information.

18. The system of claim 17, wherein the use condition comprises in-use and non-in-use conditions, and wherein the rental fee is based on the time the downhole tool is in the in-use condition.

19. The system of claim 18 wherein the in-use condition is selected from the group consisting of operating time and time spent in the well bore.

20. The system of claim 18, wherein the usage tracker comprises a timer.
